(19) United States
(12) Patent Application Publication
(10) Pub. No.: US 2005/0201824 A1
(43) Pub. Date: Sep. 15, 2005

(54) Snap-fit connection structure

(75) Inventor: Hirokazu Mitsugi, Nagoya (JP)

Correspondence Address: Koda & Androlia;Suite 1140, 2029 Century Park East, Los Angeles, CA, 90067-2983, US

(73) Assignee: Elmo Co., Ltd.

(21) Appl. No.: 10/959,235

(22) Filed: Oct. 6, 2004

(30) Foreign Application Priority Data
Mar. 12, 2004 (JP) 2004-70171

(51) Int. Cl. F16D 1/00

(52) U.S. Cl. 403/329

(57) ABSTRACT

In a snap-fit connection structure, an engaging member is formed with a locking piece having an engagement protrusion integrally formed on a side of a distal end. The locking piece is flexed so as to be inserted into an engagement hole which is formed in an engaged member and through which the engagement protrusion is allowed to pass. The engagement protrusion has an inclined face formed so as to be continuous to a side of the locking piece while its degree of protrusion is gradually reduced from a top engaging an opening edge of the engagement hole toward the opening edge side. The engagement hole is sized so that the locking piece is allowed to be turned in it. The locking piece is turned in the engagement hole so that a sliding engagement portion between the inclined face and the opening edge is moved gradually from a portion continuous to the side of the locking piece toward a portion with a higher degree of protrusion so that the locking piece is flexed such that the engagement protrusion and the opening edge are disengaged from each other.

### BACKGROUND OF THE INVENTION

1. Field of the Invention

This invention relates to a snap-fit connection structure which detachably engages an engaging member with an engaged member.

2. Description of the Related Art

JP-A-2002-227814 discloses a snap-fit connection structure which can readily be released from an assembled state at the time of repair or discard. FIG. 5 illustrates this conventional snap-fit connection structure. The illustrated snap-fit connection structure comprises a pair of locking pieces c formed on an engaging member a. One of the locking pieces c includes an engagement protrusion b. The locking pieces c are flexed so that the engagement protrusion b formed on an engaged member d is inserted into an engagement hole e through which the engagement protrusion b can be passed. The locking piece c is recovered to its former shape when the engagement protrusion b has been passed through the engagement hole e, whereupon the engagement protrusion b is engaged with an opening edge f of the engagement hole e so that the engaging member a is detachably engaged with the engaged member d.

However, in order that the foregoing snap-fit connection structure may be released from an assembled state, a connecting piece g formed on one of the locking pieces c needs to be connected to the other connecting piece c or a separately formed connecting piece needs to be attached between locking pieces c so that a space between the locking pieces c is narrowed. Furthermore, when the engaging member is engaged with an engaged member fixed to a wall or when the engagement protrusion cannot be operated at its rear side, the engaged member fixed to the wall is required to be removed from the wall in a case where the engaged member once attached to the wall is detached.

### SUMMARY OF THE INVENTION

Therefore, an object of the present invention is to provide a snap-fit connection structure which can readily be released from its assembled state when the engaged member is detached from the engaging member.

The present invention provides a snap-fit connection structure in which an engaging member is formed with a locking piece having an engagement protrusion integrally formed on a side of a distal end thereof, the locking piece being flexed so as to be inserted into an engagement hole which is formed in an engaged member and through which the engagement protrusion is allowed to pass, and the flexed locking piece is recovered to a former state thereof when the engagement protrusion has been passed through the engagement hole, whereupon the engagement protrusion is engaged with an opening edge of the engagement hole so that the engaging member is detachably engaged with the engaged member, wherein the engagement protrusion has an inclined face formed so as to be continuous to a side of the locking piece while a degree of protrusion thereof is gradually reduced from a top thereof engaging an opening edge of the engagement hole toward the opening edge side; the engagement hole is sized so that the locking piece is allowed to be turned therein; and the locking piece is turned in the engagement hole so that a sliding engagement portion between the inclined face and the opening edge is moved gradually from a portion continuous to the side of the locking piece toward a portion with a higher degree of protrusion so that the locking piece is flexed such that the engagement protrusion and the opening edge are disengaged from each other.

In the above-described structure, the inclined face is formed so as to be continuous to a side of the locking piece while a degree of protrusion thereof is gradually reduced from a top thereof engaging an opening edge of the engagement hole toward the opening edge side. The engagement hole is sized so that the locking piece is allowed to be turned in the engagement hole. The locking piece is turned in the engagement hole so that a sliding engagement portion between the inclined face and the opening edge is moved gradually from a portion continuous to a side of the locking piece toward a portion with a higher degree of protrusion. As a result, the locking piece is flexed such that the engagement protrusion and the opening edge are disengaged from each other, whereby the snap-fit connection structure is released from the assembled state. Thus, the engaged member can readily be detached from the engaging member when the engaged member is turned on the engaging member so that the locking piece is turned in the engagement hole.

### BRIEF DESCRIPTION OF THE DRAWINGS

Other objects, features and advantages of the present invention will become clear upon reviewing the following description of the embodiment with reference to the accompanying drawings, in which:

FIG. 1 is a perspective view showing the relationship between the locking piece and the engagement hole in engagement with each other in the snap-fit connection structure in accordance with one embodiment of the present invention;

FIG. 2 is a longitudinal section of a monitor camera to which the snap-fit connection structure of the invention is applied;

FIG. 3 is a sectional view as viewed in the direction of arrow A in FIG. 2;

FIGS. 4A and 4B are sectional views showing detachment of a mounting base from a mounting bracket; and

FIGS. 5A and 5B are perspective views showing a prior art snap-fit connection structure.

### DETAILED DESCRIPTION OF THE INVENTION

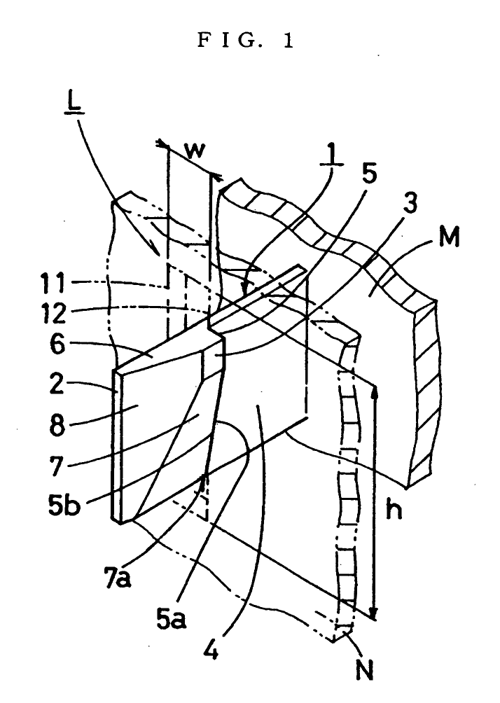

One embodiment of the present invention will be described with reference to FIGS. 1 to 4B. Referring to FIG. 1, a locking piece 1 and an engagement hole 11 both constituting the snap-fit connection structure L of the embodiment is shown. The locking piece 1 protrudes from an engaging member M and is formed into the shape of a plate. The locking piece 1 has an engagement protrusion 3 formed generally in a middle portion thereof between a root thereof and a distal end 2. The engagement protrusion 3 has an engagement face 5 rising vertically from a side 4 of the locking piece 1. The engagement face 5 is adapted to engage a open edge 12 of an engagement hole 11 which will be described later. An upper face 6 of the engagement protrusion 3 is tapered toward the distal end 2.

A generally triangular engagement face 5a extends from a middle portion of the engagement face 5 of the engagement protrusion 3 and is continuous to the side 4 of the locking piece 1 while a degree of protrusion thereof is gradually reduced. An inclined face 7 extends from an edge 5b of the triangular engagement face 5a toward the distal end 2 and is continuous to the side 4 while a degree of protrusion thereof is gradually reduced at the same rate as the triangular engagement face 5a. The inclined face 7 is also continuous to an inclined face 8 extending from the tapered top 6 of the engagement protrusion 3.

An engaged member N is formed with an engagement hole 11 formed into the shape of a longitudinal rectangle. The engagement hole 11 has a width w set so that the engagement protrusion 5 is allowed to pass through the engagement hole 11 while the locking piece 1 is flexed. Furthermore, the engagement hole 11 has a height h set to be larger than a width of the locking piece 1 so that the locking piece 1 is allowed to be turned.

In a case where the locking piece 1 is inserted through the engagement hole 11, the locking piece 1 is flexed in such a direction as to depart from an opening edge 12 when the engagement protrusion 3 passes through the engagement hole 11. When the engagement protrusion 3 has passed through the engagement hole 11, the flexed locking piece 1 is recovered to its former shape and the engagement faces 5 and 5a of the engagement protrusion 3 engage the opening edge of the engagement hole 11, whereby the engaging member M is engaged with the engaged member N.

When the engaging member M is to be disengaged from the engaged member N, the engaged member N is turned relative to the engaging member M in such a direction that a lower part of the engagement hole 11 is raised and the distal end 2 side of the locking piece 1 is lowered. As a result, a sliding engagement portion between the inclined face 7 of the triangular inclined face 5a and the opening edge 12 is moved gradually from a portion 7a continuous to the lower end of the side 4 of the locking piece 1 toward a portion with a higher degree of protrusion so that the locking piece 1 is flexed such that the engagement protrusions 5 and 5a are gradually departed from the opening edge 12 thereby to be disengaged from each other, whereupon the snap-fit connection structure L is released from the assembled state.

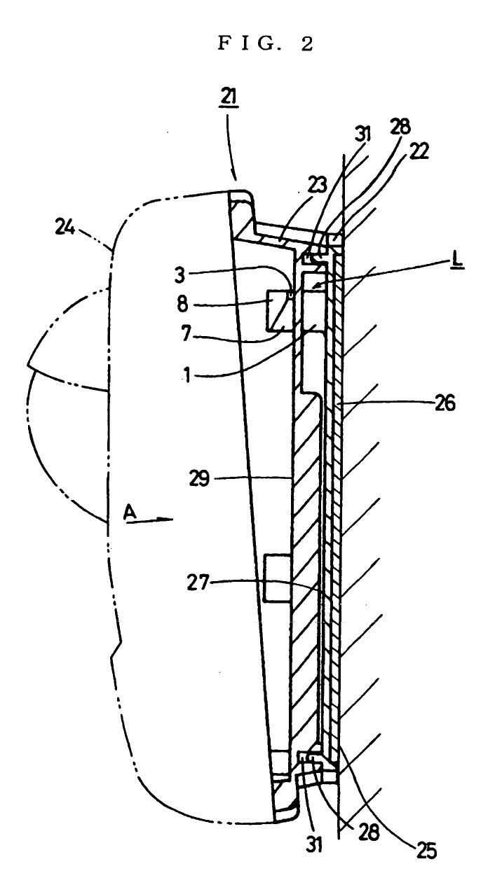

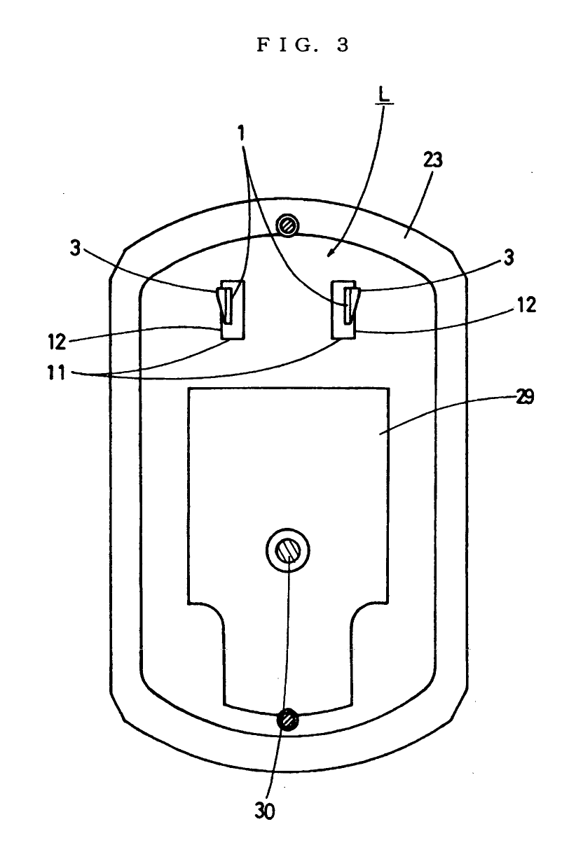

FIG. 2 shows monitor camera equipment 21 to which the snap-fit connection structure L of the embodiment is applied. FIG. 3 also shows the monitor camera equipment 21 as viewed in the direction of arrow A in FIG. 2. The monitor camera equipment 21 comprises a mounting base 22 serving as the engaging member, a mounting bracket 23 serving as the engaged member and a monitor camera 24 mounted on the mounting bracket 23. The mounting base 22 is fixed to a mounting face 25 such as a wall or ceiling with a buffering member (sponge) 26 being interposed therebetween. The mounting base 22 has a mounting face 27 formed with a pair of plate-shaped protruding locking pieces 1 located at one of lengthwise ends of the mounting base 22. The mounting base 22 includes a fitting protrusion 28 surrounding the front thereof.

The mounting bracket 23 is formed with a pair of engagement holes 11 into which the locking pieces 1 are inserted respectively. The structures of the locking piece 1 and the engagement hole 11 are obvious from the description with reference to FIG. 1. The mounting bracket 23 includes a camera attachment portion 29 to which the monitor camera 24 is attached by a fastening screw 30. The mounting bracket 23 further includes a fitting concave groove 31 surrounding the underside thereof. The mounting bracket 23 is attached to the mounting base 22 by the snap-fit connection structure L which is an engagement of the engagement holes 11 and engagement protrusions 3 of the locking pieces 1 and by the fitting of the fitting protrusion 28 and the fitting concave groove 31.

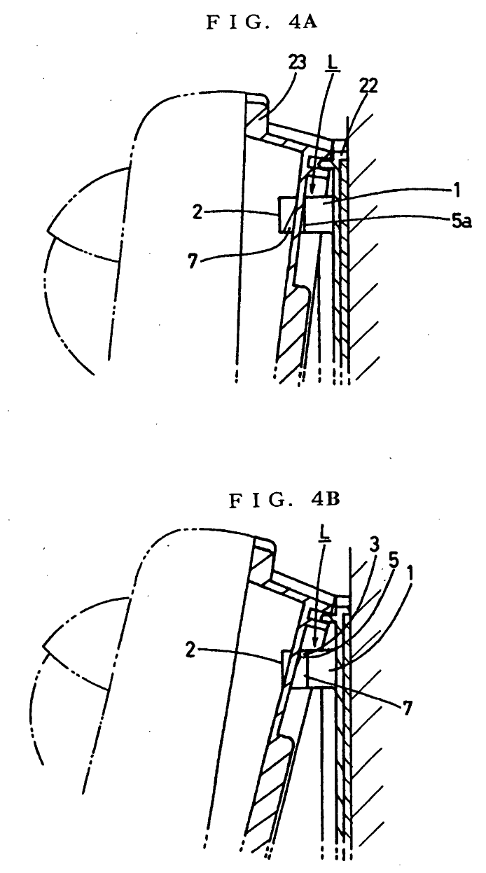

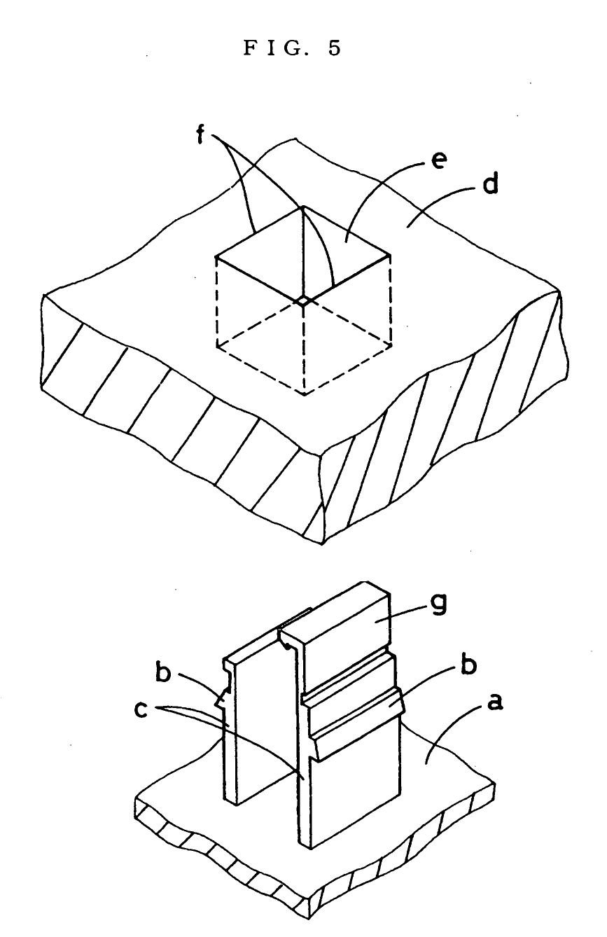

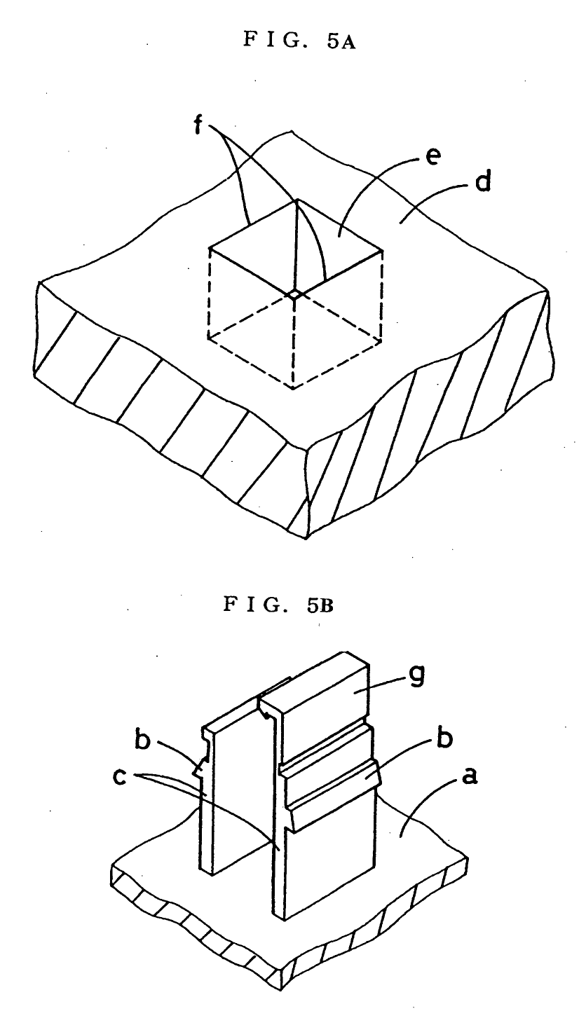

On the other hand, when the mounting bracket 23 is detached from the mounting base 22, a lower part of the bracket 23 is pulled forward and the bracket 23 is turned clockwise as viewed in FIG. 2 so that lower portions of the engagement holes 11 are raised and the distal end 2 sides of the locking pieces 1 are relatively lowered. As a result, both locking pieces 1 are turned in the respective engagement holes 11 so that the engagement protrusions 5 and 5a are gradually departed from the opening edge 12 thereby to be disengaged from the opening edge, as described above with reference to FIG. 1. Thus, the snap-fit connection structure L is released from the assembled state, whereupon the mounting bracket 23 can readily be detached from the mounting base 22. See FIGS. 4A and 4B. Additionally, the snap-fit connection structure cannot be released from the assembled state even if the mounting bracket 23 is pulled right forward from the mounting base 22.

Foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

1. A snap-fit connection structure in which an engaging member is formed with a locking piece having an engagement protrusion integrally formed on a side of a distal end thereof, the locking piece being flexed so as to be inserted into an engagement hole which is formed in an engaged member and through which the engagement protrusion is allowed to pass, and the flexed locking piece is recovered to a former state thereof when the engagement protrusion has been passed through the engagement hole, whereupon the engagement protrusion is engaged with an opening edge of the engagement hole so that the engaging member is detachably engaged with the engaged member, wherein:
the engagement protrusion has an inclined face formed so as to be continuous to a side of the locking piece while a degree of protrusion thereof is gradually reduced from a top thereof engaging an opening edge of the engagement hole toward the opening edge side;
the engagement hole is sized so that the locking piece is allowed to be turned therein; and
the locking piece is turned in the engagement hole so that a sliding engagement portion between the inclined face and the opening edge is moved gradually from a portion continuous to the side of the locking piece toward a portion with a higher degree of protrusion so that the locking piece is flexed such that the engagement protrusion and the opening edge are disengaged from each other.
